(19) United States
(12) Patent Application Publication
(10) Pub. No.: US 2009/0100641 A1
(43) Pub. Date: Apr. 23, 2009

(54) Hinge Apparatus

(75) Inventor: Shan-Yi Yang, Taipei Hsien (TW)

Correspondence Address: WPAT, PC;INTELLECTUAL PROPERTY ATTORNEYS, 2030 MAIN STREET, SUITE 1300, IRVINE, CA, 92614, US

(73) Assignee: CHENG UEI PRECISION INDUSTRY CO., LTD., Taipei Hsien (TW)

(21) Appl. No.: 11/875,888

(22) Filed: Oct. 20, 2007

(51) Int. Cl. E05F 1/12

(52) U.S. Cl. 16/303

(57) ABSTRACT

A hinge apparatus includes a hinge housing, two sliding grooves are formed in the inner wall of the hinge housing. A shaft crosses the hinge housing. A sliding cam covers the shaft, an outer projection and an inner projection are formed in the lower of the sliding cam. The outer projection is positioned at an opening angle of 180 degrees to the inner projection. An engagement cam is accepted in the hinge housing, two ribs arranged in the two sides of the engagement cam match with the sliding grooves. The upper end of the engagement cam has an outer curved surface which is composed of an assurgent curved surface and a descending curved surface. The outer projection is against the outer curved surface.

### BACKGROUND OF THE INVENTION

1. Field of the Invention

This present invention relates to a hinge apparatus, and more particularly to a hinge apparatus preferably applicable to folding electric devices such as a portable telephone, a portable computer and an electric pocket notebook.

2. The Related Art

Conventionally, portable apparatus having two housings joined by a type of hinge that follows the housings to fold upon one another is known in the art.

Referring to FIG. 1, a traditional hinge apparatus 10 comprises a housing 18, a sliding cam 11, a fixed cam 12, a spring 13, a shaft 14, an E-ring 15 and a washer 16. The sliding cam 11 is arranged in an end of the housing 18. The fixed cam 12 can be assembled in the housing 18. The spring 13 against the fixed cam 12 is accepted in the housing 18. Two pushing portions 111 are formed in the sliding cam 11. A curving surface 121 including an assurgent curved surface and a descending curved surface is formed symmetrically in the end surface of the sliding cam 12. The lower points in the curving surface 121 separate the curving surface 121 into two 180 degrees working portions. This traditional hinge apparatus 10 is used in a folding electric device. While two folding portions of the folding electric device are opened in a certain angle, the top of the pushing portion 111 slides over the top of the curving surface 121, even if the external force disappears, for the spring 13 and the curving surface 121 pushing the pushing portion 111, the folding electric device is opened. For the working portion having only 180 degrees, while the folding electric device is opened with 180 degrees, the pushing portion 111 must slide over two working portions. The opened state or the closed state of the folding electric device is limited by the housing 18 of the folding electric device, for the folding electric device fixed in the opened state or the closed state, the pushing portions 111 are not located in the lowest points of the curving surface 121, the pushing portions 111 must form an opening angle with the lowest point of the curving surface 121, and then the folding electric device is not opened 180 degrees, and not surpass 180 degrees.

### SUMMARY OF THE INVENTION

Accordingly, an object of the invention is to provide a hinge apparatus which meets the technical requirements in the above-mention hinge.

The hinge apparatus includes a hinge housing, a shaft through the hinge housing, an engagement cam accepted in the hinge housing, a sliding cam matching with the engagement cam, and a compression spring accepted in the hinge housing. The lower portion of the sliding cam has an outer projection. An insertion hole matched with the shaft is opened in the middle of the sliding cam. The upper end of the engagement cam has an outer curved surface which is composed of an assurgent curved surface and a descending curved surface. The outer projection is against the outer curved surface.

As the above description, the outer curved surface of the engagement cam of the present invention is composed of the assurgent curved surface and the descending curved surface, only 360 rotating degrees in the outer curved surface, not limit in the 180 degrees rotating angle, so the opening angle of the folding electric product will be increased, can achieve 180 degrees and beyond 180 degrees.

### BRIEF DESCRIPTION OF THE DRAWINGS

The invention, together with its objects and the advantages thereof may be best understood by reference to the following description taken in conjunction with the accompanying drawings, in which:

FIG. 1 is an exploded perspective view of a traditional hinge apparatus;

FIG. 2 is a partially cross-sectional perspective view of a hinge apparatus according to the present invention;

FIG. 3 is a perspective view of a sliding cam of the hinge apparatus;

FIG. 4 is a perspective view showing an engagement cam of the hinge apparatus;

FIG. 5 is an exploded perspective view of the hinge apparatus;

FIG. 6 is a partially cross-sectional perspective view of the sliding cam; and

FIG. 7 is a partially cross-sectional perspective view of the engagement cam.

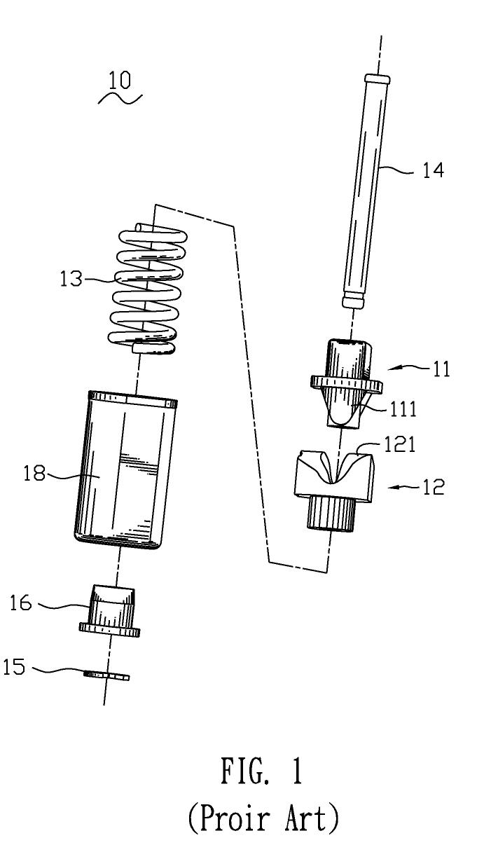

### DETAILED DESCRIPTION OF THE PREFERRED EMBODIMENT

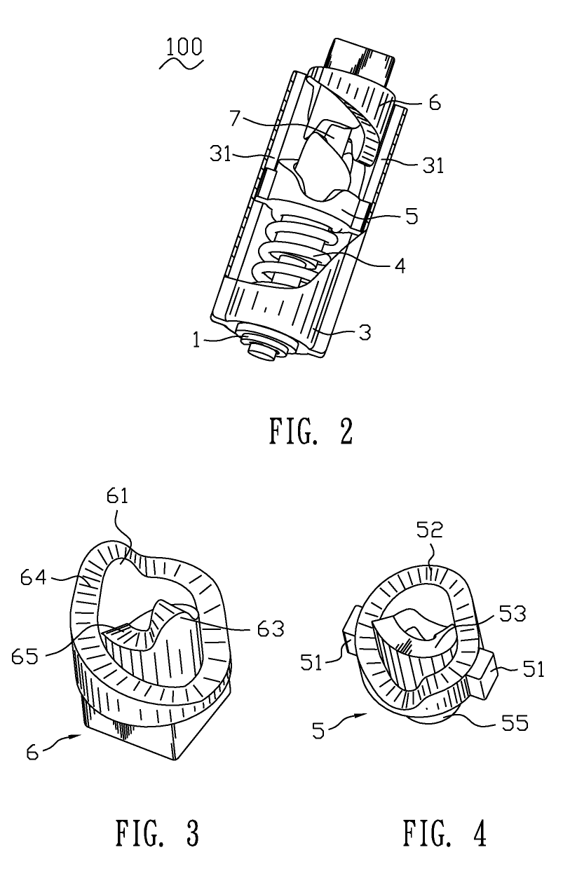

Please refer to FIGS. 2, 6 and 7, a hinge apparatus 100 according to the invention is shown. The hinge apparatus 100 comprises a hinge housing 3 showing a cylinder shape, two sliding grooves 31 are arranged in the inner wall of the hinge housing 3. A shaft 7 is fitted into the hinge housing 3, an end of the shaft 7 is accepted in a sliding cam 6. The sliding cam 6 has an outer projection 61, an insertion hole 62 matched with the shaft 7 is opened in the middle of the sliding cam 6, the lower portion of the sliding cam 6 is inserted into the hinge housing 3. An engagement cam 5 fitted to the shaft 7 is accepted into the hinge housing 3, two ribs 51 arranged in the two sides of the engagement cam 5 match with the sliding grooves 31. The upper end of the engagement cam 5 has an outer curved surface 52 which is composed of an assurgent curved surface and a descending curved surface. The outer projection 61 is against the outer curved surface 52. A compression spring 4 is against the engagement cam 5.

Referring to FIGS. 3 and 4, an inner projection 63 is formed in the sliding cam 6 and located in the inner side of the outer projection 61. The outer projection 61 is positioned at an opening angle of 180 degrees to the inner projection 63. Accordingly, an inner curved surface 53 is formed in the engagement cam 5 and located in the inner side of the outer curved surface 52. The inner curved surface 53 is positioned at an opening angle of 180 degrees to the outer curved surface 52. For additional the inner curved surface 53 matching the inner projection 63, the force that the outer projection 61 and the outer curved surface 52 make the shaft 7 slanted is balanced.

The sliding cam 6 has a cam outer surface 64 and a cam inner surface 65. The cam outer surface 64 is formed in the front end of the outer projection 61. The cam inner surface 65 is formed in the front end of the inner projection 63. The compression spring 4 and the outer curved surface 52 of the engagement cam 5 can rotate relatively to the outer projection 61, the compression spring 4 and the inner curved surface 53 of the engagement cam 5 can rotate relatively to the inner projection 63.

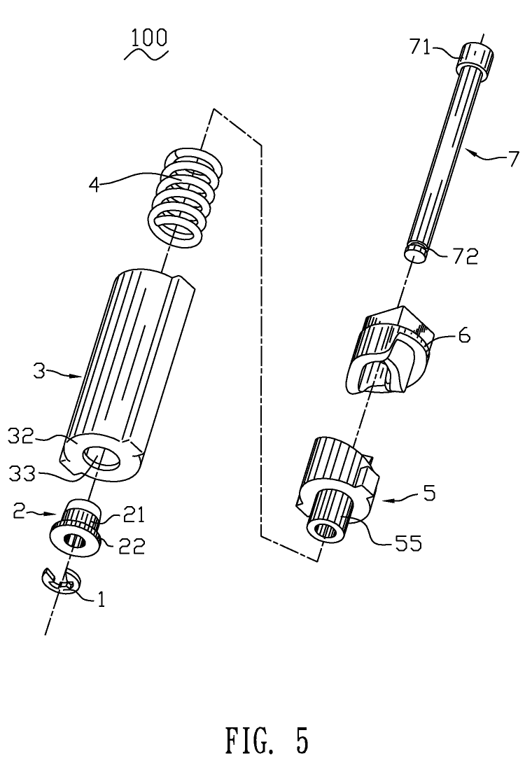

Referring to FIGS. 5 and 7, a circular hole 54 is opened in the engagement cam 5, the circular hole 54 matches with the shaft 7, and the circular hole 54 can slide along the shaft 7, therefore the engagement cam 5 can slide smoothly along the shaft 7.

Please refer to FIGS. 2 and 4, the two sliding grooves 31 are arranged symmetrically in the inner wall of the hinge housing 3. The two ribs 51 are corresponding to the sliding grooves 31. The sliding grooves 31 and the ribs 51 make the engagement cam 5 accepted in the hinge housing 3 reposefully. The ribs 51 are accepted in the sliding grooves 31, the ribs 51 slide along the sliding grooves 31 with the engagement cam 5.

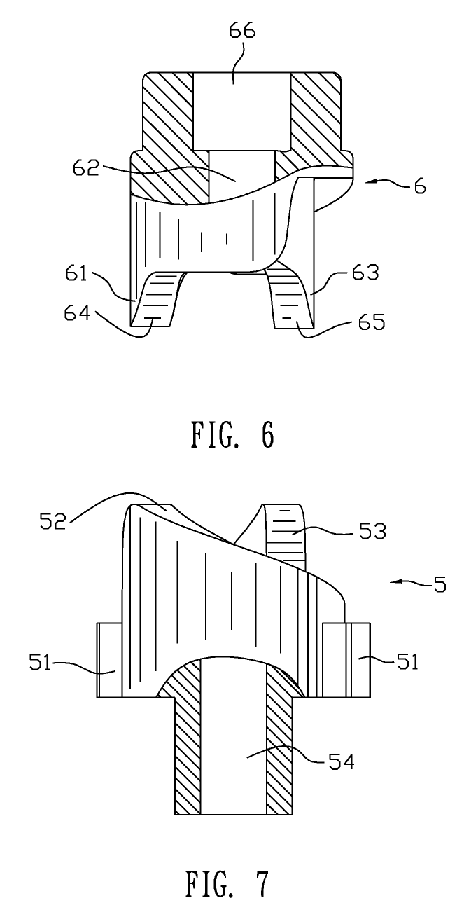

Referring to FIGS. 5 and 6 again, the hinge housing 3 has a housing base 32. An axle hole 33 is opened in the middle of the housing base 32. The front end of the shaft 7 forms a flange portion 71 showing a column shape. An accepting groove 66 is opened in the upper surface of the sliding cam 6. The flange portion 71 is inserted into the accepting groove 66. The rear end of the shaft 7 passes out from the axle hole 33, a locking groove 72 is opened in the rear end of the shaft 7. An E-ring 1 is fixed in the locking groove 72.

Referring to FIG. 5, a limit portion 55 projects from the bottom surface of the engagement cam 5. The compression spring 4 covers the limit portion 55 and resists the engagement cam 5. The rear end of the shaft 7 is fitted into a limit lump 2. The limit lump 2 has a resisting portion 21 showing a hollow column shape. A projecting portion 22 projects from the side of the resisting portion 21. The other end of the compression spring 4 covers the resisting portion 21 and resists the projecting portion 22.

In the above description, the sliding cam 6 rotates corresponding to the hinge housing 3, the engagement cam 5 slides corresponding to the hinge housing 3. In other embodiments, the sliding cam 6 can be fixed, the engagement cam 5 and the hinge housing 3 rotates corresponding to the sliding cam 6. In any case, the engagement cam 5 rotates corresponding to the sliding cam 6. The assurgent curved surface of the engagement cam 5 is opposite to the descending curved surface of the engagement cam 5, which relates with the sliding cam 6.

While the hinge apparatus 100 operates, the sliding cam 6 and the hinge housing 3 are located with the two portions of an electric product respectively.

As the above description, the outer curved surface 52 and the inner curved surface 53 consists of an assurgent curved surface and a descending curved surface, then the circle movement of the engagement cam 5 corresponding to the sliding cam 6 only has a working stage. So the two portions of the folded electric product having the hinge apparatus 100 can be opened in a large range, not limit 180 degrees.

An embodiment of the present invention has been discussed in detail. However, this embodiment is merely a specific example for clarifying the technical contents of the present invention and the present invention is not to be construed in a restricted sense as limited to this specific example. Thus, the spirit and scope of the present invention are limited only by the appended claims.

What is claimed is:

1. A hinge apparatus, comprising:
a hinge housing showing a cylinder shape, two sliding grooves arranged in the inner side of the hinge housing;
a shaft through the hinge housing;
a sliding cam surrounding the shaft and received in the hinge housing, the beneath of the sliding cam having an outer projection;
an engagement cam accepted in the hinge housing, the upper end of the engagement cam having an outer curved surface, the outer curved surface having an assurgent curved surface and a descending curved surface jointing each other smoothly at two ends thereof to form a highest point and a lowest point opposite to the highest point, the outer projection against the outer curved surface, two ribs formed in the side of the engagement cam, the ribs accepted in the sliding grooves and sliding with the engagement came along the sliding grooves of the hinge housing; and
a compression spring, an end of the compression spring against the sliding cam.

2. The hinge apparatus as set forth in claim 1, wherein the inner side of the outer projection forms an inner projection on the sliding cam, the outer projection is positioned at an opening angle of 180 degrees to the inner projection, an inner curved surface is formed in the engagement cam and located in the inner side of the outer curved surface, the inner curved surface is positioned at an opening angle of 180 degrees to the outer curved surface.

3. The hinge apparatus as set forth in claim 2, wherein the sliding cam has a cam outer surface and a cam inner surface, the cam outer surface is formed in the front end of the outer projection, the cam inner surface is formed in the front end of the inner projection.

4. The hinge apparatus as set forth in claim 1, wherein the engagement cam has a circular hole, the circular hole matches with the shaft and slides along the shaft.

5. The hinge apparatus as set forth in claim 1, wherein the hinge housing has a housing base, an axle hole is opened in the middle of the base, the front end of the shaft forms a flange portion showing a column shape, an accepting groove is opened in the upper surface of the sliding cam, the flange portion is inserted into the accepting groove, the rear end of the shaft passes out from the axle hole, a locking groove is opened in the rear end of the shaft, an E-ring is fixed in the locking groove.

6. The hinge apparatus as set forth in claim 1, wherein the bottom surface of the engagement cam projects to form a limit portion, the compression spring covers the limit portion, the shaft is fitted into the limit lump, the limit lump has a resisting portion showing a hollow column shape, a projecting portion projects from the side of the resisting portion, the other end of the compression spring covers the resisting portion and resists the projecting portion.
